(19) United States
(12) Patent Application Publication
(10) Pub. No.: US 2015/0115543 A1
(43) Pub. Date: Apr. 30, 2015

(54) Oil Seal

(71) Applicant: NOK CORPORATION, Tokyo (JP)

(72) Inventor: Takehiro NAKAGAWA, Fukushima-Shi (JP)

(21) Appl. No.: 14/502,308

(22) Filed: Sep. 30, 2014

(30) Foreign Application Priority Data
Oct. 29, 2013 (JP) 2013-224147

(51) Int. Cl. F16J 15/32

(52) U.S. Cl. CPC F16J 15/3244; F16J 15/3204
USPC 277/559

(57) ABSTRACT

An oil seal includes a bidirectional thread formed by the combination of a normal thread and a reverse thread and including ship-bottom-shaped threads as the threads, in which sealing performance by the thread can be improved. A normal thread and a reverse thread that exhibit a pumping action on a sealing fluid are provided side by side on the circumference on an atmospheric-side surface of a seal lip sliding portion. The normal thread and an reverse thread are respectively threads in which a parallel thread that begins from a lip tip and a ship-bottom-shaped thread continuous with the parallel thread are integrally continuous.

### CROSS-REFERENCE TO RELATED APPLICATIONS

This application claims the benefit and priority of Japanese Application No. 2013-224147, filed Oct. 29, 2013. The entire disclosure of the above application is incorporated herein by reference.

### FIELD

The present invention relates to oil seals associated with a sealing technology, and more specifically to oil seals equipped with a thread that attains a fluid pumping action at a sliding portion of a seal lip. The oil seal of the present disclosure is used in automobile-related fields, general machinery fields or the like, for example.

### BACKGROUND

For example, conventionally, an oil seal used at a right side and a left side of a differential gear for a vehicle such as an automobile has a bidirectional thread specification that disposes side-by-side on a circumference a normal thread and a reverse thread that attain a pumping action on a sealed fluid in an atmospheric-side surface of a seal lip sliding portion. Therefore, the oil seals used on both the right side and the left side are commonly used.

Conversely, in recent years, an improvement in sealing performance of oil seals is needed; consideration has been given to adopting a ship-bottom shaped thread that has an even more excellent pumping action, rather than conventional parallel threads used as threads for both directions.

However, when adopting the ship-bottom shaped thread as threads for both directions in this way, spray leaks are generated by the unique thread shape. To prevent this, it was necessary to terminate the two-direction thread specifications, and to use a single-direction thread specification.

Therefore, by using oil seals with different specifications for the right side and the left side of the differential gear, there is concern regarding an incorrect assembly of the left and right seals.

### PRIOR ART DOCUMENTS

Patent Document 1: Japanese unexamined patent application publication Hei 1-312274
Patent Document 2: Japanese Patent application publication 3278349

### SUMMARY

### Problem to be Solved by the Disclosure

In view of the points described above, an object of the present disclosure is to provide an oil seal that increases sealing performance by the thread, in an oil seal with bidirectional thread specifications composed by combining a normal thread and a reverse thread, and is equipped with a ship-bottom shaped thread as the thread.

### Means for Solving the Problems

To attain the aforementioned object, an oil seal is characterized by a normal thread and a reverse thread that attain a pumping action on a sealing fluid at an atmospheric-side surface of a seal lip sliding portion are disposed, side-by-side on a circumference; the normal thread and the reverse thread respectively are threads in which a parallel thread that begins from the lip tip, and a ship-bottom-shaped thread continuous with the normal thread are integrally continuous; the ship-bottom-shaped thread in the normal thread is formed such that the inclination angle of an inclination surface at a backward side in a normal rotational direction of the axis of the ship-bottom-shaped thread is larger than the inclination angle of an inclination surface at a forward side in the normal rotational direction of the axis; and the ship-bottom-shaped thread in the reverse thread is formed such that the inclination angle of an inclination surface on a forward side in a normal rotational direction of the axis of the ship-bottom-shaped thread is larger than the inclination angle of an inclination surface on a backward side in the normal rotational direction of the axis.

Also, the oil seal is characterized by the parallel thread in the normal thread being formed such that the inclination angle of an inclination surface on a backward side in a normal rotational direction of the axis of the parallel thread and the inclination angle of an inclination surface on a forward side in the normal rotational direction of the axis are equal to each other, and the parallel thread in the reverse thread also being formed such that the inclination angle of an inclination surface on a forward side in a normal rotational direction of the axis of the parallel thread and the inclination angle of an inclination surface on a backward side in the normal rotational direction of the axis are equal to each other.

Also, the oil seal is characterized by the parallel thread in the normal thread being formed such that the inclination angle of an inclination surface on a backward side in a normal rotational direction of the axis of the parallel thread is larger than the inclination angle of an inclination surface on a forward side in the normal rotational direction of the axis, and the parallel thread in the reverse thread is formed such that the inclination angle of an inclination surface on a forward side in a normal rotational direction of the axis of the parallel thread is larger than the inclination angle of an inclination surface on a backward side in the normal rotational direction of the axis.

The bidirectional thread is formed by a combination of a normal thread that (normal thread portion) that attains sealing functionality by pushing back sealing fluid to the sealing-fluid by a pumping action when the axis is rotating (normal rotation) in a normal direction, and a reverse thread (reverse thread portion) that attains sealing functionality by pushing back sealing fluid by the pumping action when the axis is rotating (reverse rotation) in a reverse direction.

In the present disclosure, the normal thread and the reverse thread respectively are composed by a combination of a parallel thread that begins from the lip tip, and the ship-bottom-shaped thread continuous with the parallel thread. The parallel thread and the ship-bottom-shaped thread are integrally continuous. The parallel thread is a thread formed so that a long, square sectional shape (including a thread height and a thread width) of the parallel thread is equally formed along an entire length of the thread. The ship-bottom-shaped thread is a thread equipped with a shape where a long, square sectional shape (including a thread height and a thread width) of that thread is gradually larger from the lip tip (sealing fluid side) to the atmosphere side. A long, right-angle sectional shape of the parallel thread is triangular or substantially triangular; a long, right-angle sectional shape of the ship-bottom-shaped thread is triangular or substantially triangular.

Also, pursuant to the present invention, the ship-bottom-shaped thread in the normal thread is formed so that an inclination angle of an inclination surface at a forward side in the normal rotational direction of the axis is larger than an inclination angle of an inclination surface at a forward side in the normal rotational direction of the axis. The inclination angle of the inclination surface of the backward side in the normal rotational direction of the axis of the ship-bottom-shaped thread in the normal thread is an inclination surface at a side to recover (push back) sealing fluid when the axis is rotating in the normal direction, and the inclination surface of the forward side in the normal rotational direction of the axis of the ship-bottom-shaped thread in the normal thread is an inclination surface (an inclination surface at the reverse thread side) at an opposite side.

Also, pursuant to the present disclosure, the ship-bottom-shaped thread in the ship-bottom-shaped thread is formed so that an inclination angle of an inclination surface at a forward side in the normal rotational direction of the axis is larger than an inclination angle of an inclination surface at a backward side in the normal rotational direction of the axis. The inclination angle of the inclination surface of the forward side in the normal rotational direction of the axis of the ship-bottom-shaped thread in the reverse thread is an inclination surface at a side to recover (push back) sealing fluid when the axis is rotating in the reverse direction, and the inclination surface of the backward side in the normal rotational direction of the axis of the ship-bottom-shaped thread in the reverse thread is an inclination surface (an inclination surface at the reverse thread side) at an opposite side.

Therefore, with the present disclosure, because the inclination surface at the backward side in the normal rotational direction of the axis of the ship-bottom-shaped thread in the normal thread which is the inclination surface at the side to recover the sealing fluid as described above, is formed with a large inclination angle, when the axis rotates in the normal direction, the inclination surface becomes a wall (dam) to the flow of sealing fluid, so it is easier to recover sealing fluid. Also, because the inclination surface at the backward side in the normal rotational direction of the axis of the ship-bottom-shaped thread in the reverse thread, which is the inclination surface at the opposite side, is formed with a small inclination angle, when the axis rotates in the normal direction, sealing fluid easily overcomes this thread, thereby suppressing the flow of sealing fluid to the atmosphere side by flowing on this inclination surface, and it is also possible to suppress spray leaks.

Also when the axis is rotating in the reverse direction, this action faces in reverse on the circumference, attaining the following.

In other words, with the present disclosure, because the inclination surface at the forward side in the normal rotational direction of the axis of the ship-bottom-shaped thread in the normal thread which is the inclination surface at the side to recover the sealing fluid as described above, is larger than the inclination angle, when the axis rotates in the reverse direction, the inclination surface becomes a wall (dam) to the flow of sealing fluid, so it is easier to recover sealing fluid. Also, because the inclination surface at the forward side in the normal rotational direction of the axis of the ship-bottom-shaped thread in the normal thread, which is the inclination surface at the opposite side, is formed with a small inclination angle, when the axis rotates in the reverse direction, sealing fluid easily overcomes this thread, thereby suppressing the flow of sealing fluid to the atmosphere side by flowing on this inclination surface, and it is also possible to suppress spray leaks.

Therefore, even if the axis rotates in either the normal or the reverse direction, it is easy to recover sealing fluid in this way so it is possible to improve sealing performance, and to suppress the generation of spray leaks.

Also, the present disclosure as described above improves oil seal performance by mutually varying the inclination angles of right and left inclination surface of the ship-bottom-shaped thread in the normal thread and the reverse thread, but the same thing can be said for the parallel thread at the lip tip side on which the ship-bottom-shaped thread is continuous.

In other words, because the inclination surface at the backward side in the normal rotational direction of the axis of the parallel thread in the normal thread which is the inclination surface at the side to recover the sealing fluid, is formed with a large inclination angle, when the axis rotates in the normal direction, the inclination surface becomes a wall (dam) to the flow of sealing fluid, so it is easier to recover sealing fluid. Also, because the inclination surface at the backward side in the normal rotational direction of the axis of the parallel thread in the reverse thread, which is the inclination surface at the opposite side, is formed with a small inclination angle, when the axis rotates in the normal direction, sealing fluid easily overcomes this thread, thereby suppressing the flow of sealing fluid to the atmosphere side by flowing on this inclination surface, and it is also possible to suppress spray leaks.

Also when the axis is rotating in the reverse direction, this action faces in reverse on the circumference, attaining the following.

In other words, because the inclination surface at the forward side in the normal rotational direction of the axis of the parallel thread in the reverse thread which is the inclination surface at the side to recover the sealing fluid, is formed with a large inclination angle, when the axis rotates in the reverse direction, the inclination surface becomes a wall (dam) to the flow of sealing fluid, so it is easier to recover sealing fluid. Also, because the inclination surface at the forward side in the normal rotational direction of the axis of the parallel thread in the normal thread, which is the inclination surface at the opposite side, is formed with a small inclination angle, when the axis rotates in the reverse direction, sealing fluid easily overcomes this thread, thereby suppressing the flow of sealing fluid to the atmosphere side by flowing on this inclination surface, and it is also possible to suppress spray leaks.

Therefore, even if the axis rotates in either the normal or the reverse direction, it is easy to recover sealing fluid in this way so it is possible to improve sealing performance, and to suppress the generation of spray leaks.

However, mutually varying inclination angles of the left and right inclination surfaces of the parallel threads in the normal thread and the reverse thread is optional. It is acceptable for the inclination angle of the inclination surface at a backward side in the normal rotational direction of the axis of the normal thread and the parallel thread, and the inclination angle of the inclination surface at a forward side in the normal rotational direction of the axis to be equal. It is also acceptable for the inclination angle of the inclination surface at a forward side in the normal rotational direction of the axis of the reverse thread and the parallel thread, and the inclination angle of the inclination surface at a backward side in the normal rotational direction of the axis to be equal. In such cases, the parallel thread collapses symmetrically at the sealing surface so a uniform sealing surface pressure on the circumference is attained, and the sealing state is stable.

### Effect of the Present Disclosure

The present disclosure attains the following effects. In other words, as described above, the present disclosure simultaneously attains an effect easily to recover sealing fluid, and an effect to suppress a generation of spray leaks, with the configuration described above. Therefore, an object of the present disclosure is to increase sealing performance by a thread, in an oil seal that has a bidirectional thread specification, equipped with a ship-bottom shaped thread as the threads.

### DRAWINGS

FIG. 1 is a sectional view of an essential portion of an oil seal pursuant to a first embodiment of the present disclosure;

FIG. 2(A) is an enlarged sectional view of line A-A in FIG. 1;

FIG. 2(B) is an enlarged sectional view of line B-B in FIG. 1;

FIG. 2(C) is an enlarged sectional view of line C-C in FIG. 1;

FIG. 2(D) is an enlarged sectional view of line D-D in FIG. 1;

FIG. 3 is a sectional view of an essential portion of an oil seal pursuant to a second embodiment of the present disclosure; and

FIG. 4(A) is an enlarged sectional view of line E-E in FIG. 3;

FIG. 4(B) is an enlarged sectional view of line F-F in FIG. 3;

FIG. 4(C) is an enlarged sectional view of line G-G in FIG. 3;

FIG. 4(D) is an enlarged sectional view of line H-H in FIG. 3.

### DETAILED DESCRIPTION

The present disclosure includes the following embodiments: Inclination angles of screw thread on a large ship-bottom shaped thread are left-right asymmetrical. The screw-thread inclination angle is large at an inclination surface on a side that recovers oil. Oil is easily recovered by becoming a wall to a flow of oil. By making a small inclination angle for the screw thread at an inclination surface of a reverse thread side at an opposite side, oil easily rides over the screw thread; the reverse thread suppresses an action that reduces suction capacity.

Generates a main pumping at the large ship-bottom shaped thread. The parallel threads are smaller so as not to deform a sealing surface. The parallel threads play a role in a rectifying action up to the sealing surface.

A type that extends the asymmetrical inclination angle of the ship-bottom shaped threads up to the parallel threads. Pursuant to this type, it is possible to maintain pumping up to the sealing surface.

A type where the ship-bottom shaped thread has an asymmetrical inclination angle, but the parallel threads have a symmetrical inclination angle. Pursuant to this type, the parallel threads collapse symmetrically at the sealing surface so the sealing state is stable. A sealing surface pressure is attained that is uniform around a ring.

### EMBODIMENT

Below, embodiments of the present disclosure will now be described with reference to the drawings.

### First Embodiment

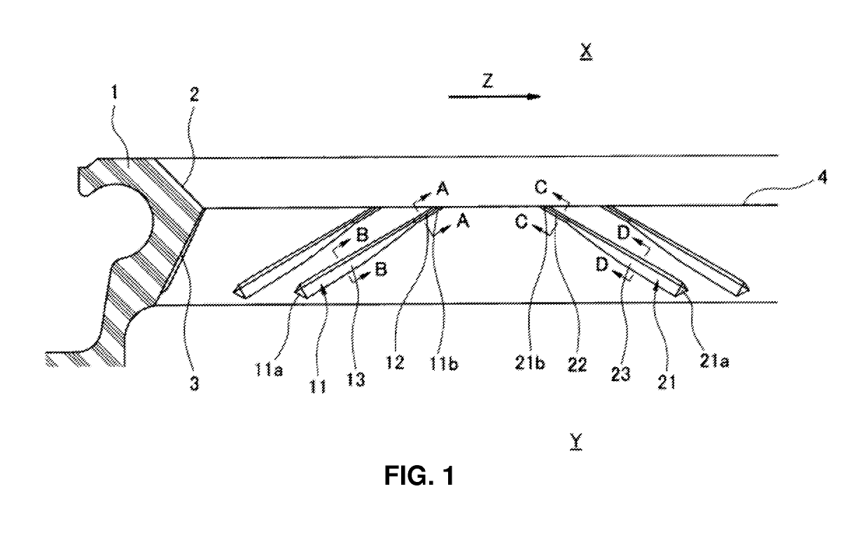

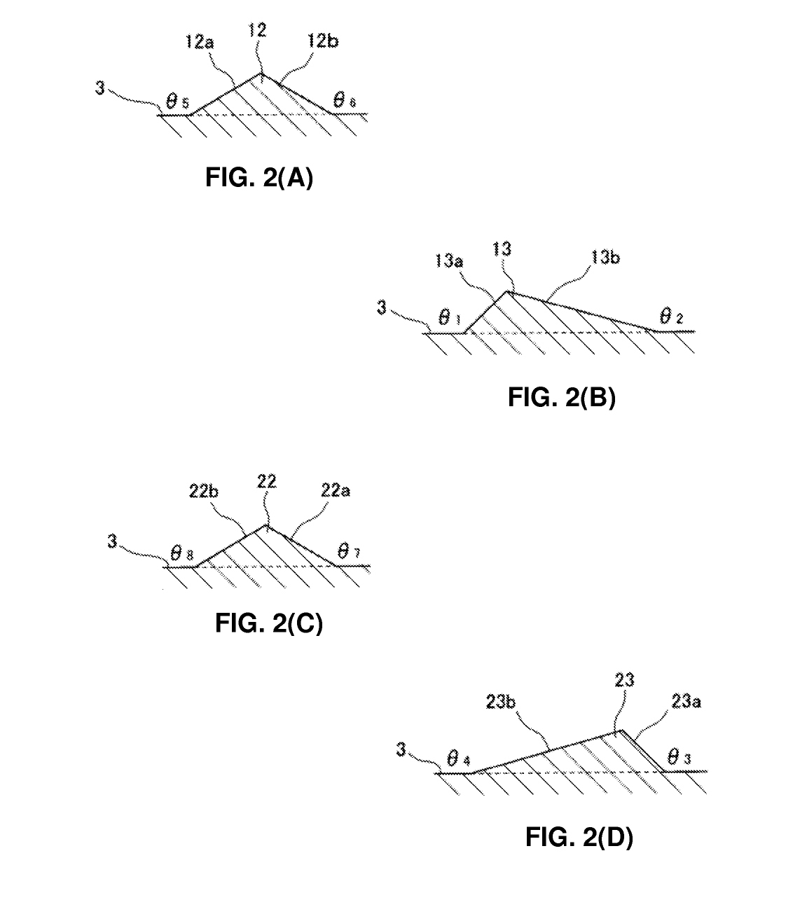

FIGS. 1 and 2 show an oil seal pursuant to a first embodiment of the present disclosure. The oil seal pursuant to this embodiment is double-rotating seal that corresponds to a rotation of an axis (a mate member, not shown in the drawing) in both a normal and a reverse direction. It has the following constitution.

In other words, as shown in FIG. 1, a seal lip 1 that is closely fitted to be able to slide on a circumferential surface of an axis by a rubber-like elastic member mounted (vulcanized bonding) onto a metallic ring (not shown in the drawing) is disposed. A sealing-fluid side-surface (inclination surface) 2 and an atmospheric-side surface (inclination surface) 3 are disposed on a seal lip 1 tip sliding portion. The symbol 4 denotes the lip tip intersected by both side surfaces 2 and 3; it has an apex-shape.

A normal thread (normal thread portion) 11 that attains sealing functionality by pushing back sealing fluid to the sealing-fluid side X by a pumping action when the axis is rotating (normal rotation, arrow Z) in a normal direction, and a reverse thread (reverse thread portion) 21 that attains sealing functionality by pushing back sealing fluid to the sealing-fluid side X by the pumping action when the axis is rotating (reverse rotation) in a reverse direction are disposed on the atmospheric-side surface 3 of the two side surfaces 2 and 3 on the seal lip 1. One or a plurality of these normal threads 11 and reverse threads 21 are disposed alternately on a circumference (for example, eight are equally arranged), or disposed half-way around the circumference. In any case, they are disposed side-by-side around the circumference.

The normal thread 11 is composed of a helicoid projection. The direction of the helix obliquely faces from an atmospheric-side portion 11a toward a front of the normal rotational direction of the axis Z to a sealing-fluid side end portion 11b. Also, parallel threads 12 that start from the lip tip 4 and the ship-bottom-shaped thread 13 continuous with the parallel thread are integrally continuous on the normal thread 11.

A long, right-angle sectional shape (including the thread height and the thread width) of the parallel thread 12 is equally formed along an entire length of the thread; a long, right-angle sectional shape (including the thread height and the thread width) of the ship-bottom-shaped thread 13 has a shape that gradually increases from the lip tip 4 (sealing fluid side X) to the atmosphere side Y. The long, right-angle sectional shapes of the parallel threads 12, and the ship-bottom-shaped thread 13 are each triangular and substantially triangular.

Conversely, the reverse thread 21 is composed of a helicoid projection. The direction of the helix obliquely faces from an atmospheric-side portion 21a toward a rear of the normal rotational direction of the axis Z to a sealing-fluid side end portion 21b. Also, the parallel threads 22 that starts from the lip tip 4 and the ship-bottom-shaped thread 23 continuous with the parallel thread are integrally continuous on the reverse thread 21.

A long, right-angle sectional shape (including the thread height and the thread width) of the parallel thread 22 is equally formed along an entire length of the thread; a long, right-angle sectional shape (including the thread height and the thread width) of the ship-bottom-shaped thread 23 has a shape that gradually increases from the lip tip 4 (sealing fluid side X) to the atmosphere side Y. The long, right-angle sectional shapes of the parallel threads 22, and the ship-bottom-shaped thread 23 are each triangular and substantially triangular.

Also, as a particularly characteristic configuration of the present disclosure, as shown in the expanded section in FIG. 2(B), on the normal thread 11 and the ship-bottom-shaped thread 13, an inclination angle (a rising angle from the side surface 3) θ₁ of an inclination surface 13a at a backward side in the normal rotational direction of the axis is formed to be larger than an inclination angle θ₂ of the inclination surface 13b at a forward side in the normal rotational direction of the axis (θ₁>θ₂); as shown in FIG. 2(D), an inclination angle θ₃ of the inclination surface 23a at a forward side in the normal rotational direction of the axis of the ship-bottom-shaped thread 23 on the reverse thread 21, is formed to be larger than an inclination angle θ₄ of the inclination surface 23b at a backward side in the normal rotational direction of the axis (θ₃>θ₄). A range of 40-50° is preferred as a size of the inclination angles θ₁ and θ₃; 45° is even more preferred. A range of 10-20° is preferred as a size of the inclination angles θ₂ and θ₄; 15° is even more preferred.

Also, as shown in FIG. 2(A), on the normal thread 11 and the ship-bottom-shaped thread 12, an inclination angle θ5 of an inclination surface 12a at a backward side in the normal rotational direction of the axis is formed to be equal to an inclination angle θ₆ of the inclination surface 12b at a forward side in the normal rotational direction of the axis (θ₅=θ₆); as shown in FIG. 2(C), on the parallel thread 22 in the reverse thread 21 is formed an inclination angle θ₇ of an inclination surface 22a at a forward side in the normal rotational direction of the axis is formed to be equal to an inclination angle θ₈ of an inclination surface 22b at a backward side in the normal rotational direction of the axis (θ₇=θ₈). A range of 25-35° is preferred as a size of the inclination angles θ₅, θ₆, θ₇, and θ₈; 30° is even more preferred.

The oil seal configured as describe above is mounted as a common part to left and right sides of a differential gear on a vehicle such as an automobile or the like, as described above, for example. Characteristic points with that configuration that attain operations and effects are described below.

In other words, in the oil seal equipped with the configuration described above, the normal thread 11 and the reverse thread 21 each is equipped with ship-bottom-shaped threads 13, and 23 having shapes whose thread heights gradually become larger from lip tip 4 to the atmosphere side Y, so it is difficult for the thread height to become lower as friction advances that is associated with sliding on the axis. Therefore, it is difficult for the pumping action to drop.

Also, when the axis rotates in the normal direction, the inclination angle θ₁ on the inclination surface 13a at the backward side of the normal rotational direction of the axis of the ship-bottom-shaped thread 13 on the normal thread 11 which becomes an inclination surface at a side to recover the sealing fluid, is formed to become larger, so the inclination surface 13a at the backward side becomes a wall (dam) for the flow of sealing fluid; sealing fluid is easily recovered. Therefore, an excellent pumping action is attained. Also, the inclination angle θ₄ of the inclination surface 23b at the backward side in the normal rotational direction of the axis of the ship-bottom-shaped thread 23 in the reverse thread 21 which becomes an inclination surface at an opposite side, is formed to be small. For that reason, it is easy for the sealing fluid to overcome this thread 23. Therefore, it is possible to suppress an amount flowing to the atmosphere side Y by the sealing fluid flowing to the inclination surface 23b, and further to suppress an amount that is sprayed.

Also, when the axis rotates in the reverse direction, the inclination angle θ₃ on the inclination surface 23a at the forward side of the normal rotational direction of the axis of the ship-bottom-shaped thread 23 in the reverse thread 21 which becomes an inclination surface at a side to recover the sealing fluid, is formed to be larger, so the inclination surface 23a at the forward side becomes a wall (dam) for the flow of sealing fluid; sealing fluid is easily recovered. Therefore, an excellent pumping action is attained. Also, the inclination angle θ₂ of the inclination surface 13b at the forward side in the normal rotational direction of the axis of the ship-bottom-shaped thread 13 in the normal thread 11 which becomes an inclination surface at an opposite side, is formed to be small. For that reason, it is easy for the sealing fluid to overcome this thread 13. Therefore, it is possible to suppress an amount flowing to the atmosphere side Y by the sealing fluid flowing to the inclination surface 13b, and further to suppress an amount that is sprayed.

### Second Embodiment

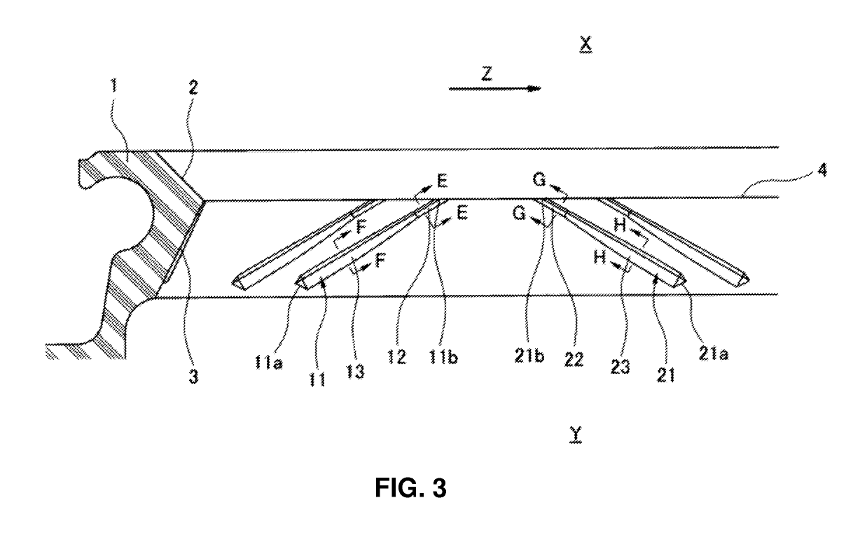

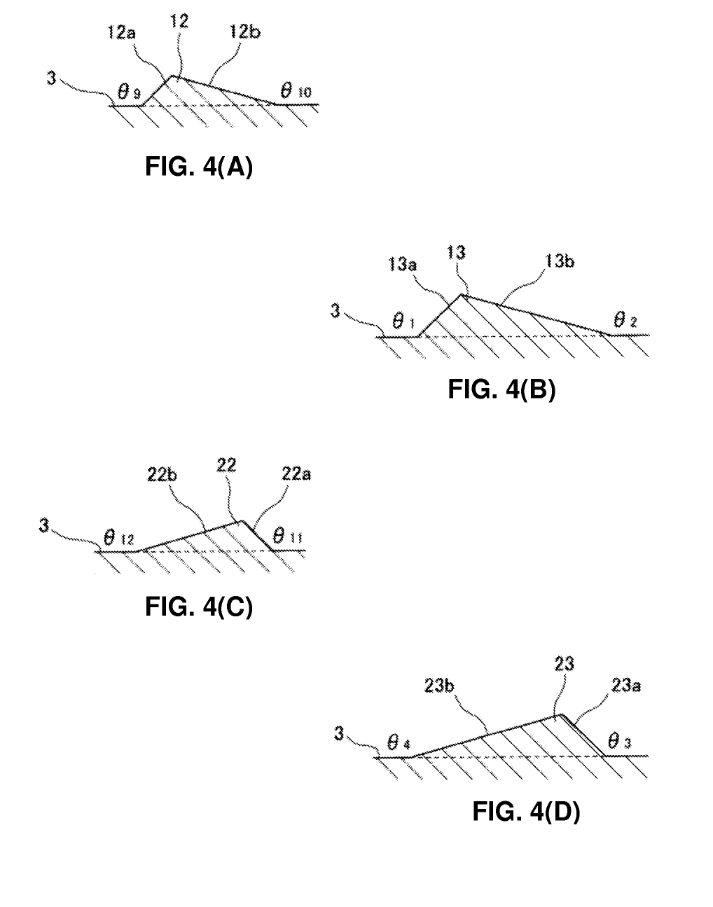

FIGS. 3 and 4(A)-4(D) show an oil seal pursuant to a second embodiment of the present disclosure. The oil seal pursuant to this embodiment is double-rotating seal that corresponds to a rotation of an axis (a mate member, not shown in the drawing) in both a normal and a reverse direction. It has the following constitution.

In other words, as shown in FIG. 3, a seal lip 1 that is closely fitted to be able to slide on a circumferential surface of an axis by a rubber-like elastic member mounted (vulcanized bonding) onto a metallic ring (not shown in the drawing) is disposed. A sealing-fluid side-surface (inclined surface) 2 and an atmospheric-side surface (inclined surface) 3 are disposed on the seal lip 1 sliding portion. The symbol 4 denotes the lip tip intersected by both side surfaces 2 and 3; it has an apex-shape.

A normal thread (normal thread portion) 11 that attains sealing functionality by pushing back sealing fluid to the sealing-fluid side X by a pumping action when the axis is rotating (normal rotation, arrow Z) in a normal direction, and a reverse thread (reverse thread portion) 21 that attains sealing functionality by pushing back sealing fluid to the sealing-fluid side X by the pumping action when the axis is rotating (reverse rotation) in a reverse direction are disposed on the atmospheric-side surface 3 of the two side surfaces 2 and 3 on the seal lip 1. One or a plurality of these normal threads 11 and reverse threads 21 are disposed alternately on a circumference (for example, eight are equally arranged), or disposed half-way around the circumference. In any case, they are disposed side-by-side around the circumference.

The normal thread 11 is composed of a helicoid projection. The direction of the helix obliquely faces from an atmospheric-side portion 11a toward a front of the normal rotational direction of the axis Z to a sealing-fluid side end portion 11b. Also, parallel threads 12 that start from a lip tip 4 and the ship-bottom-shaped thread 13 continuous with the parallel thread are integrally continuous on the normal thread 11.

A long, right-angle sectional shape (including the thread height and the thread width) of the parallel thread 12 is equally formed along an entire length of the thread; a long, right-angle sectional shape (including the thread height and the thread width) of the ship-bottom-shaped thread 13 has a shape that gradually increases from the lip tip 4 (sealing fluid side X) to the atmosphere side Y. The long, right-angle sectional shapes of the parallel threads 12, and the ship-bottom-shaped thread 13 are each triangular and substantially triangular.

Conversely, the reverse thread 21 is composed of a helicoid projection. The direction of the helix obliquely faces from an atmospheric-side portion 21a toward a rear of the normal rotational direction of the axis Z to a sealing-fluid side end portion 21b. Also, the parallel threads 22 that starts from the lip tip 4 and the ship-bottom-shaped thread 23 continuous with the parallel thread are integrally continuous on the reverse thread 21.

A long, right-angle sectional shape (including the thread height and the thread width) of the parallel thread 22 is equally formed along an entire length of the thread; a long, right-angle sectional shape (including the thread height and the thread width) of the ship-bottom-shaped thread 23 has a shape that gradually increases from the lip tip 4 (sealing fluid side X) to the atmosphere side Y. The long, right-angle sectional shapes of the parallel threads 22, and the ship-bottom-shaped thread 23 are each triangular and substantially triangular.

Also, as a particularly characteristic configuration of the present disclosure, as shown in the expanded section of FIG. 4(B), on the normal thread 11 and the ship-bottom-shaped thread 13, an inclination angle (a rising angle from the side surface 3) θ₁ of an inclination surface 13a at a backward side in the normal rotational direction of the axis is formed to be larger than an inclination angle θ₂ of the inclination surface 13b at a forward side in the normal rotational direction of the axis (θ₁>θ₂); as shown in FIG. 4(D), an inclination angle θ₃ of the inclination surface 23a at a forward side in the normal rotational direction of the axis of the ship-bottom-shaped thread 23 in the reverse thread 21, is formed to be larger than an inclination angle θ₄ of the inclination surface 23b at a backward side in the normal rotational direction of the axis (θ₃>θ₄). A range of 40-50° is preferred as a size of the inclination angles θ1 and θ3; 45° is even more preferred. A range of 10-20° is preferred as a size of the inclination angles θ₂ and θ₄; 15° is even more preferred.

Also, in the first embodiment, sectional shapes of the parallel threads 12, and 22 are left-right symmetrical, but in the second embodiment, the sectional shapes of the parallel threads 12, and 22 are left-right asymmetrical, for example.

In other words, with the second embodiment, as shown in FIG. 4(A), on the parallel threads 12 in the normal thread 11, an inclination angle θ₉ of the inclination surface 12a at a backward side in the normal rotational direction of the axis is formed to be larger than an inclination angle θ₁₀ of the inclination surface 12b at a forward side in the normal rotational direction of the axis (θ₉>θ₁₀); as shown in FIG. 4(C), on the parallel screw 22 in the reverse thread 21 is formed an inclination angle θ₁₁ of the inclination surface 22a at a forward side in the normal rotational direction of the axis is formed to be larger than an inclination angle θ₁₂ of the inclination surface 22b at a backward side in the normal rotational direction of the axis (θ₁₁>θ₁₂). A range of 40-50° is preferred as a size of the inclination angles θ₉ and θ₁₁; 45° is even more preferred. A range of 10-20° is preferred as a size of the inclination angles θ₁₀ and θ₁₂; 15° is even more preferred.

The oil seal configured as describe above is mounted as a common part to a left and a right side of a differential gear on a vehicle such as an automobile or the like, as described above, for example. It has characteristics in the points that it attain the operations and effects described below with that configuration.

In other words, in the oil seal equipped with the configuration described above, the normal thread 11 and the reverse thread 21 each is equipped with ship-bottom-shaped threads 13, and 23 having shapes whose thread heights gradually become larger from lip tip 4 to the atmosphere side Y, so it is difficult for the thread height to become lower as friction advances that is associated with sliding on the axis. Therefore, it is difficult for the pumping action to drop.

Also, when the axis rotates in the normal direction, the inclination angle θ₁ on the inclination surface 13a at the backward side of the normal rotational direction of the axis of the ship-bottom-shaped thread 13 in the normal thread 11 which becomes an inclination surface at a side to recover the sealing fluid, is formed to become large, so the inclination surface 13a at the backward side becomes a wall (dam) for the flow of sealing fluid; sealing fluid is easily recovered. Therefore, an excellent pumping action is attained. Also, the inclination angle θ₄ of the inclination surface 23b at the backward side in the normal rotational direction of the axis of the ship-bottom-shaped thread 23 in the reverse thread 21 which becomes an inclination surface at an opposite side, is formed to be small. For that reason, it is easy for the sealing fluid to overcome this thread 23. Therefore, it is possible to suppress an amount flowing to the atmosphere side Y by the sealing fluid flowing to the inclination surface 23b, and further to suppress an amount that is sprayed.

Also, when the axis rotates in the reverse direction, the inclination angle θ3 on the inclination surface 23a at the forward side of the normal rotational direction of the axis of the ship-bottom-shaped thread 23 in the reverse thread 21 which becomes an inclination surface at a side to recover the sealing fluid, is formed to be larger, so the inclination surface 23a at the forward side becomes a wall (dam) for the flow of sealing fluid; sealing fluid is easily recovered. Therefore, an excellent pumping action is attained. Also, the inclination angle θ₂ of the inclination surface 13b at the forward side in the normal rotational direction of the axis of the ship-bottom-shaped thread 13 in the normal thread 11 which becomes an inclination surface at an opposite side, is formed to be small. For that reason, it is easy for the sealing fluid to overcome this thread 13. Therefore, it is possible to suppress an amount flowing to the atmosphere side Y by the sealing fluid flowing to the inclination surface 13b, and further to suppress an amount that is sprayed.

Also, with the second embodiment, the sectional shapes of parallel threads 12, and 22 are left-right asymmetrical, so the following operation and effect are attained as an additional item.

In other words, when the axis rotates in the normal direction, the inclination angle θ₉ on the inclination surface 12a at the backward side of the normal rotational direction of the axis of the parallel threads 12 on the normal thread 11 which becomes an inclination surface at a side to recover the sealing fluid, is formed to become larger, so the inclination surface 12a at the backward side becomes a wall (dam) for the flow of sealing fluid; sealing fluid is easily recovered. Therefore, an excellent pumping action is attained. Also, the inclination angle θ₁₂ of the inclination surface 22b at the backward side in the normal rotational direction of the axis of the parallel threads 22 on the reverse thread 21 which becomes an inclination surface at an opposite side, is formed to be small. For that reason, it is easy for the sealing fluid to overcome this thread 22. Therefore, it is possible to suppress an amount flowing to the atmosphere side Y by the sealing fluid flowing to the oblique surface 22b, and further to suppress an amount that is sprayed.

Also, when the axis rotates in the reverse direction, the inclination angle θ₁₁ on the inclination surface 22a at the forward side of the normal rotational direction of the axis of the parallel threads 22 on the reverse thread 21 which becomes an inclination surface at a side to recover the sealing fluid, is formed to become larger, so the inclination surface 22a at the forward side becomes a wall (dam) for the flow of sealing fluid; sealing fluid is easily recovered. Therefore, an excellent pumping action is attained. Also, the inclination angle θ₁₀ of the inclination surface 12b at the forward side in the normal rotational direction of the axis of the parallel threads 12 on the normal thread 11 which becomes an inclination surface at an opposite side, is formed to be small. For that reason, it is easy for the sealing fluid to overcome this thread 12. Therefore, it is possible to suppress an amount flowing to the atmosphere side Y by the sealing fluid flowing to the inclination surface 12b, and further to suppress an amount that is sprayed.

### EXPLANATION OF LETTERS OR NUMERALS

1 Seal lip
2 Sealing-fluid side surface
3 Atmospheric-side surface
4 Lip tip
11 Normal thread
11a Atmosphere side end
11b Sealing-fluid side end
12, 22 Parallel thread
12a, 13a, 22b, 23b Inclination surface at backward side in normal rotational direction of the axis
12b, 13b, 22a, 23a Inclination surface at forward side in normal rotational direction of the axis
13, 23 Ship-bottom-shaped thread
21 Reverse thread
θ₁-θ₁₂ Inclination angle
X Sealing-fluid side
Y Atmosphere side

1. An oil seal, comprising:
a normal thread and a reverse thread that exhibit a pumping action on a sealing fluid are provided side by side on a circumference on an atmospheric-side surface of a seal lip sliding portion,
wherein the normal thread and the reverse thread are respectively threads in which a parallel thread that begins from a lip tip and a ship-bottom-shaped thread continuous with the parallel thread are integrally continuous,
wherein the ship-bottom-shaped thread in the normal thread is formed such that the inclination angle of an inclination surface on a backward side in a normal rotational direction of the axis of the ship-bottom-shaped thread is larger than the inclination angle of an inclination surface on a forward side in the normal rotational direction of the axis, and
wherein the ship-bottom-shaped thread in the reverse thread is formed such that the inclination angle of an inclination surface on a forward side in a normal rotational direction of the axis of the ship-bottom-shaped thread is larger than the inclination angle of an inclination surface on a backward side in the normal rotational direction of the axis.

2. The oil seal as claimed in claim 1,
wherein the parallel thread in the normal thread is formed such that the inclination angle of an inclination surface on a backward side in a normal rotational direction of the axis of the parallel thread and the inclination angle of an inclination surface on a forward side in the normal rotational direction of the axis are equal to each other, and
wherein the parallel thread in the reverse thread is also formed such that the inclination angle of an inclination surface on a forward side in a normal rotational direction of the axis of the parallel thread and the inclination angle of an inclination surface on a backward side in the normal rotational direction of the axis are equal to each other.

3. The oil seal as claimed in claim 1,
wherein the parallel thread in the normal thread is formed such that the inclination angle of an inclination surface on a backward side in a normal rotational direction of the axis of the parallel thread is larger than the inclination angle of an inclination surface on a forward side in the normal rotational direction of the axis, and
wherein the parallel thread in the reverse thread is formed such that the inclination angle of an inclination surface on a forward side in a normal rotational direction of the axis of the parallel thread is larger than the inclination angle of an inclination surface on a backward side in the normal rotational direction of the axis.
